(19) United States
(12) Patent Application Publication
(10) Pub. No.: US 2004/0031144 A1
(43) Pub. Date: Feb. 19, 2004

(54) Coaxial cable braid everting tool

(76) Inventor: Michael Holland, Santa Barbara, CA (US)

Correspondence Address: Michael G. Petit, P.O. Box 91929, Santa Barbara, CA, 93190-1929, US

(21) Appl. No.: 10/219,806

(22) Filed: Aug. 14, 2002

(51) Int. Cl. H01B 13/20; B23P 19/00

(52) U.S. Cl. 29/825; 29/828; 29/758

(57) ABSTRACT

A tool for everting a stripped portion of the braided conductive shielding of a coaxial cable in preparation for the attachment of a coaxial cable connector thereto. In order to attach a coaxial cable connector to the end of a coaxial cable, a portion of the cable jacket near the end of the coaxial cable is first stripped by a suitable stripping tool to expose a portion of the underlying braided shielding. The tool of the present invention is employed to evert the exposed portion of the braided shielding layer and fold it over the unstripped adjacent jacket. A preferred embodiment of the tool includes a handle with a circular opening therein dimensioned to receive a coaxial cable inserted thereinto. The circular opening has a plurality of bristles disposed around the circumference thereof. A fixed end of the bristles is supported by the handle. The free opposing end of the bristles extend radially inwardly toward the center of the circular opening. When the stripped end of the coaxial cable is inserted into the circular opening in a direction orthogonal to the bristles, the plurality of bristles engage the cut ends of the conductive filaments of the braided shielding and comb the filaments rearwardly to overlie the unstripped portion of jacket adjacent thereto. The cable is then removed from the circular opening by lateral motion through a slot in the circular opening.

### BACKGROUND OF THE INVENTION

1. Field of the Invention

The invention relates generally to tools for attaching a male coaxial connector to a free end of a coaxial cable and, more particularly, to a tool for everting the braided shielding on a stripped portion of the free end of a coaxial cable.

2. Prior Art

In order to attach an end of a coaxial cable to a coaxial cable connector, the end of the cable must first be prepared. An insulative outer jacket on the cable is stripped back to expose a layer of braided shielding concentrically overlying a dielectric layer and a central conductor. The end of the central conductor projects beyond the exposed end of the dielectric layer. The exposed layer of braided shielding overlying the dielectric layer is then flared, everted and folded back over the insulating outer jacket. When the foregoing steps have been completed, the end of the coaxial cable is ready to be inserted within the axial bore of a coaxial cable connector for attachment thereto.

Various methods of flaring and everting the braided shielding under field installation conditions are known in the art. Installers commonly perform the flaring and everting operation using their fingernails or a penknife. While this method is expedient, it is dangerous inasmuch as personal injury can occur, and it provides nonuniform results. It is desirable to provide a tool that enables a cable installer to flare and evert the braided shielding on a coaxial cable in a repeatable, predictable manner without exposing himself/herself to personal injury.

### SUMMARY

It is an object of the invention to provide a tool that is operable, under field installation conditions, for flaring and everting an exposed portion of braided shielding on the stripped end of a coaxial cable.

A tool in accordance with the present invention meeting the above objective includes a handle having a grasping portion and a working end. In a first preferred embodiment, the working end of the tool includes a substantially circular aperture having a plurality of bristles projecting thereinto. The aperture is dimensioned to receive the stripped end of a coaxial cable thrust in an axial direction thereinto. The aperture has a slot communicating therewith that enables a coaxial cable thrust into the aperture to be removed from the aperture by moving the cable in a lateral direction with respect to the axis of the aperture.

In another embodiment of a tool for flaring and everting an exposed portion of a braided shielding on a stripped end of a coaxial cable in preparation for the attachment of a coaxial cable connector thereto, the coaxial cable comprising a outer jacket, the tool comprises a handle portion adapted to be grasped by the hand; and a working portion integral with the handle portion. The working portion comprises a pair of parallel opposing jaws having a slot therebetween. A plurality of elastically deformable bristles are disposed within the slot, each bristle comprising the plurality of bristles having a fixed end attached to one of the two jaws, and a free end extending into the slot. The free ends of of the plurality of bristles collectively define a fuzzy slit therebetween disposed within the slot. When the stripped end of a coaxial cable is thrust into the fuzzy slit, the bristles comb the braided shielding back over the cable jacket thereby preparing the stripped end of the cable for the installation of a coaxial connector thereon.

The features of the invention believed to be novel are set forth with particularity in the appended claims. However the invention itself, both as to organization and method of operation, together with further objects and advantages thereof may be best understood by reference to the following description taken in conjunction with the accompanying drawings in which:

### BRIEF DESCRIPTION OF THE DRAWINGS

FIG. 1 is an elevational view showing the stripped end of a coaxial cable.

FIG. 2 is an elevational view of a coaxial cable braid flaring and everting tool in accordance with a preferred embodiment of the present invention.

FIG. 3 is a top view illustrating the use of the flaring and everting tool of FIG. 2 to evert the braided shielding on the stripped end of the coaxial cable shown in FIG. 1.

FIG. 4 is an elevational view showing the prepared end of a coaxial cable illustrated in FIG. 1 with the conductive braid folded back to overlie a portion of the protective jacket.

FIG. 5 is an elevational view of a coaxial cable braid flaring and everting tool in accordance with a second embodiment of the present invention.

FIG. 6 is a perspective view of a coaxial cable braid flaring and everting tool in accordance with a third embodiment of the present invention.

### DESCRIPTION OF THE PREFERRED EMBODIMENTS

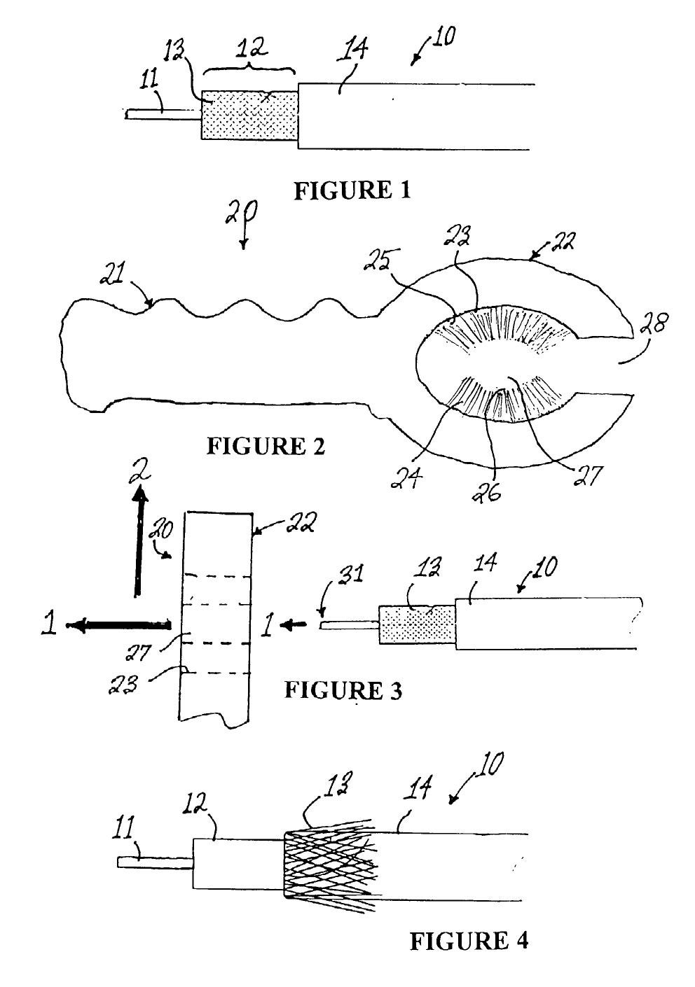

Turning now to FIG. 1 the partially prepared (i.e., stripped) end of a coaxial cable 10 is shown in elevational view. Prior to coupling a coaxial cable to a connector, the end of the cable to receive the connector must first be prepared. A stripping tool (not shown) is used by an installer to expose a portion of the central conductor 11, a length of the dielectric core 12 and a conductive (grounding) braid 13, as shown in FIG. 1. The respective lengths of each of the elements comprising the coaxial cable 10 that are exposed by the stripping tool are in accordance with industry standards. Following exposure of the conductive braid 13, the exposed portion of conductive braid 13 is flared and folded back to overlie the protective jacket 14 as shown in FIG. 4. The coaxial cable 10 may further include one or more layers of an electrically conductive foil (not shown) underlying the conductive braid. The thickness of the conductive braid 13 may vary, depending on the manufacturer.

With reference now to FIG. 2, a flaring and everting tool in accordance with a preferred embodiment of the present invention is shown in side elevational view at numeral 20. The tool 20 has a handle portion 21 adapted to be grasped within the hand of an installer and a working portion 22 affixed to the handle portion 21. The working portion 22 of the tool 20 has a circular or elliptical aperture 23 therein with a plurality of elastically deformable bristles 24 affixed at a fixed end 25 thereof to the circumference of the aperture 23. The opposing free ends 26 of the bristles 24 extend inwardly to form a fuzzy aperture 27 which is substantially concentric with aperture 23. A cable removal slot 28 is provided that connects the aperture 23 to the external environment.

A preferred method for using the tool 20 to flare and evert the braided shielding 13 of the cable 10 (as shown in FIG. 4) is illustrated in top view in FIG. 3. The stripped end 31 of the coaxial cable 10 is advanced into the fuzzy aperture 27 in the direction of broad arrow 1 until the stripped, exposed portion of the braided shielding 13 passes through the fuzzy aperture 27. The bristles 24 part the braided filaments comprising the braided shielding 13 and comb the separated filaments backward to overlie the jacket 14 as shown in FIG. 4. The cable is then removed from within the fuzzy aperture 27 by lateral motion through the slot 28 in the direction illustrated by broad arrow 2. The process is repeated until the filaments comprising the braided shielding are satisfactorily separated, everted and disposed to overlie the portion of jacket 14 adjacent thereto as shown in FIG. 4. The slot 28 in the aperture 23 enables the cable to be removed from the fuzzy aperture 27 without retracting the cable through the fuzzy aperture.

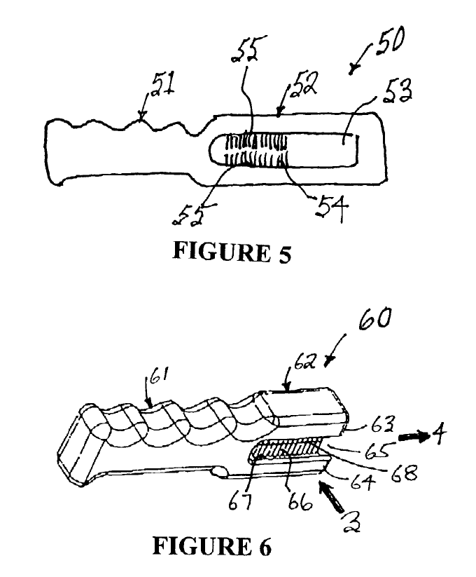

A second embodiment of the present invention is illustrated in elevational view at numeral 50 in FIG. 5. The second preferred embodiment 50 of the tool comprises a handle portion 51 and a working portion 52 integral with the handle portion. The working portion 52 includes a rectangular or elliptical aperture 53 therewithin, a first portion of the aperture 53 having a plurality of bristles 54 mounted on opposing surfaces within the aperture 53, the bristles being attached at a fixed end thereof to a portion of the peripheral surface 55 of the aperture 53. The free ends of the opposing bristles extend inwardly and are substantially in juxtaposition with one another. The remaining portion of the aperture, i.e., the portion containing no bristles, is a void dimensioned to permit a jacketed coaxial cable to pass therethrough. In use, the stripped end of a coaxial cable is inserted between the (deformable) bristles from the side in the direction of the paper. The bristles part and comb the exposed braided shielding on the cable back over the outer jacket as the cable is advanced between the bristles. The cable is then moved laterally into the void portion of the aperture and retracted. The process is repeated until the braided shielding is everted and overlies the jacket. A male-type coaxial connector may then be attached to the end of the cable.

A third preferred embodiment of a tool in accordance with the present invention is shown in perspective view in FIG. 6. The tool 60 includes a handle portion 61 adapted to br grasped by a hand and a working portion 62 comprising a pair of opposing jaws 63 and 64 with a slot 65 therebetween. A plurality of bristles 66 are attached to the opposing surfaces of the jaws at a fixed end 67 thereof such that the free ends 68 of the bristles mounted on opposing surfaces are in juxtaposition and form a fuzzy slit therebetween. In use, the stripped end of a coaxial cable is thrust laterally, i.e., in a direction orthogonal to the direction of the bristles indicated by broad arrow 3, into the fuzzy slit between the juxtaposed free ends of the bristles until the braided shielding emerges from the opposite side of the tool. The cable is then removed from between the jaws of the tool by moving the cable in the direction of broad arrow 4. The cable is rotated and reiserted between the bristles in the direction of broad arrow 3 and the process repeated until the exposed portion of the braided shielding is everted and combed to overlie the adjacent portion of the cable jacket.

While particular embodiments of the present invention have been illustrated and described, it would be obvious to those skilled in the art that various other changes and modifications can be made without departing from the spirit and scope of the invention. For example, the handle portion of the everting tool of the present invention may include another tool operable for performing one or more other steps in the coaxial cable connector installation process. It is therefore intended to cover in the appended claims all such changes and modifications that are within the scope of this invention.

What I claim is:

1. A tool for flaring and everting an exposed portion of a braided shielding on a stripped end of a coaxial cable in preparation for the attachment of a coaxial cable connector thereto, the coaxial cable comprising a outer jacket, the tool comprising:
(a) a handle portion adapted to be grasped by the hand; and
(b) a working portion integral with said handle portion, said working portion comprising an aperture having a circumference; and
(c) a plurality of elastically deformable bristles, each bristle comprising said plurality of bristles having a fixed end affixed to said circumference of said aperture and a free end extending into said aperture, said free ends of said plurality of bristles collectively defining a fuzzy aperture; and
(d) a slot extending outwardly from said circumference of said aperture.

2. A tool for flaring and everting an exposed portion of a braided shielding on a stripped end of a coaxial cable in preparation for the attachment of a coaxial cable connector thereto, the coaxial cable comprising a outer jacket, the tool comprising:
(a) a handle portion adapted to be grasped by the hand; and
(b) a working portion integral with said handle portion, said working portion comprising a pair of parallel opposing jaws having a slot therebetween; and
(c) a plurality of elastically deformable bristles disposed within said slot, each bristle comprising said plurality of bristles having a fixed end attached to one of said pair of jaws and a free end extending into said slot, said free ends of said plurality of bristles collectively defining a fuzzy slit within said slot.

3. A method for everting the exposed portion of braided shielding on a stripped end of a coaxial cable comprising the steps of:
(a) presenting a coaxial cable having an outer jacket and a layer of braided shielding underlying said outer jacket wherein a portion of said outer jacket on an end of the coaxial cable is stripped to expose a portion of said braided shielding; then
(b) presenting a tool in accordance with claim 1 or claim 2; then
(c) thrusting said stripped end of said cable between said free ends of said plurality of bristles.
